(19) United States
(12) Patent Application Publication
(10) Pub. No.: US 2007/0118799 A1
(43) Pub. Date: May 24, 2007

(54) On-screen display apparatus

(76) Inventors: Ming-Chin Kao, Yung Ho City (TW); Chia-Ming Lee, Yung Ho City (TW); Chia-Yao Chang, Yung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/281,450

(22) Filed: Nov. 18, 2005

(51) Int. Cl. G09G 5/00

(52) U.S. Cl. 715/701; 715/840; 345/184

(57) ABSTRACT

An on-screen display apparatus for displaying button function information on a display is provided. The on-screen display apparatus includes a pushing interpreter, a power button interpreter and a button function information output device. The pushing interpreter is used for determining whether one of a plurality of buttons of the display is pushed. The power button interpreter is electrically connected to the pushing interpreter for determining whether a power button is pushed when one of the buttons of the display is pushed. The button function information output device is electrically connected to the power button interpreter for outputting the button function information onto the display when one of the buttons of the display is pushed while the power button is not pushed.

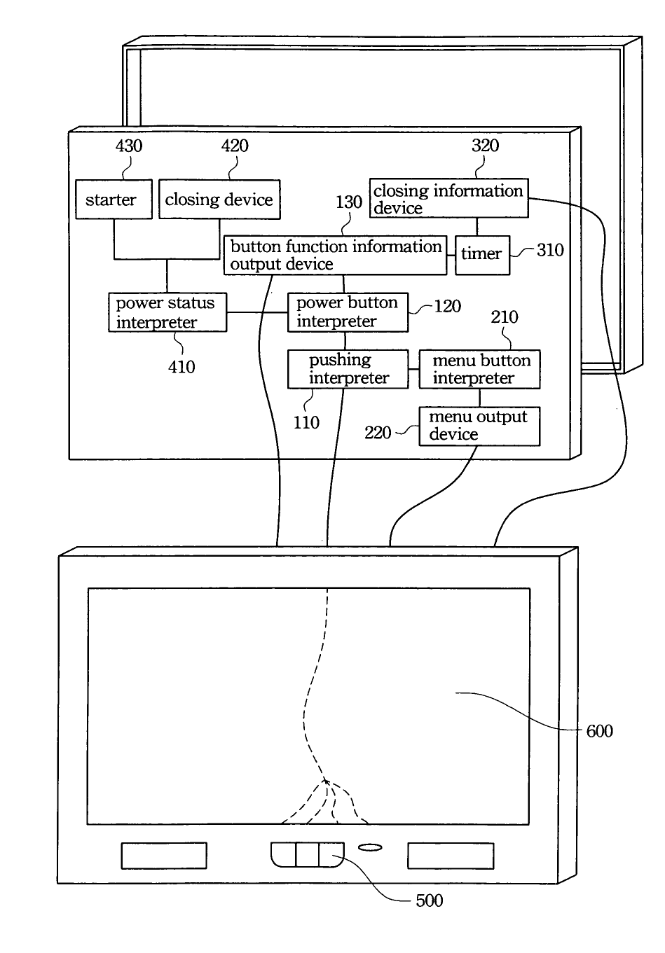

### BACKGROUND

1. Field of Invention

The present invention relates to an on-screen display apparatus. More particularly, the present invention relates to an apparatus for displaying button function information on a display.

2. Description of Related Art

Displays such as cathode ray tube displays and liquid crystal displays play an important role in modern life, especially with the popularity of personal computers in recent years. Although parameters of the display regarding display behavior are optimized when the display leaves the factory, these parameters still need to be adjusted according to user preferences. These parameters may be contrast, brightness, and vertical or horizontal size and position.

An on-screen display apparatus enables users to adjust parameters conveniently. A display with an on-screen display apparatus may comprise a mode button. When users push the mode button, a signal transmits to a controller of the on-screen display apparatus immediately. Then, a on-screen display image is overlapped onto the display such that the users can see the variation of the parameters and adjust the parameters such as the contrast, brightness, or vertical or horizontal size and position.

However, the on-screen display image generated by a typical on-screen display apparatus only has a menu, not any button function information. Thus, manufacturers of the display need to print words or symbols representing the button function information on the shell of the display. This increases the cost of the display, especially the cost of the display shell. Moreover, the button function information needs to be printed on a position that is conveniently seen by users, which limits the artistic design of the display. Furthermore, the designer of the display is artistically limited such that a preferred symbol or word font for representing the button function information is unavailable. In addition, the button function information is often small and indistinct in order to accommodate the small size of the shell.

### SUMMARY

It is therefore an aspect of the present invention to provide an on-screen display apparatus for providing varied types of button function information.

It is another aspect of the present invention to provide an on-screen display apparatus for reducing the printing cost of the shell of a display.

It is still another aspect of the present invention to provide an on-screen display apparatus for relaxing the artistic design limitation of a display.

It is yet another aspect of the present invention to provide an on-screen display apparatus for providing big and distinct button function information.

In accordance with the foregoing and other aspects of the present invention, an on-screen display apparatus able to be configured in a display is provided. The on-screen display apparatus includes a pushing interpreter, a power button interpreter and a button function information output device. The pushing interpreter is used for determining whether one of a plurality of buttons of the display is pushed. The power button interpreter is electrically connected to the pushing interpreter for determining whether a power button is pushed when one of the buttons of the display is pushed. The button function information output device is electrically connected to the power button interpreter for outputting button function information onto the display when one of the buttons of the display is pushed while the power button is not pushed.

According to one preferred embodiment, the on-screen display apparatus further includes a menu button interpreter. The menu button interpreter is electrically connected to the pushing interpreter for determining whether a menu button is pushed when the button function information is displayed on the display while one of the buttons of the display is pushed. Moreover, a menu output device may be electrically connected to the menu button interpreter for outputting a menu onto the display when the menu button is pushed.

In addition, the on-screen display apparatus may include a timer electrically connected to the button function information output device for timing how long the button function information has been displayed on the display. Furthermore, a closing information device may be electrically connected to the timer for closing the button function information displayed on the display when a time timed by the timer equals a predetermined time.

In one embodiment of the invention, a power status interpreter may be electrically connected to the power button interpreter for determining a power status of the display when the power button is pushed. If the power button is pushed while the power status of the display is off, a starter electrically connected to the power status interpreter may be employed to turn on the display. On the contrary, if the power button is pushed while the power status of the display is on, a closing device electrically connected to the power status interpreter may be employed to turn off the display.

Moreover, the display according to preferred embodiments of the invention excludes words or symbols printed on a display shell that represent button functions.

As embodied and broadly described herein, the invention provides an on-screen display apparatus able to display button function information on a display. Thus, manufacturers need not print words or symbols representing button functions on the display shell, such that the cost of the display shell is reduced and the artistic design limitation of the display is relaxed. Furthermore, designers can design varied types of button function information without artistic limitation because the button function information is displayed on the display rather than printed on the shell of the display. Similarly, the on-screen display is able to provide big and distinct button function information without being limited to the size of the shell of the display.

It is to be understood that both the foregoing general description and the following detailed description are by examples and are intended to provide further explanation of the invention as claimed.

### BRIEF DESCRIPTION OF THE DRAWINGS

The invention can be more fully understood by reading the following detailed description of the preferred embodiment, with reference made to the accompanying drawing as follows:

The FIGURE is a structural diagram of an on-screen display according to one preferred embodiment of the invention.

### DESCRIPTION OF THE PREFERRED EMBODIMENT

Reference will now be made in detail to the present preferred embodiments of the invention, an example of which is illustrated in the accompanying drawing. Wherever possible, the same reference numbers are used in the drawing and the description to refer to the same or like parts.

Reference is made to the FIGURE, which is a structural diagram of an on-screen display according to one preferred embodiment of the invention. An on-screen display apparatus able to be configured in a display 600 is provided in the FIGURE. The on-screen display apparatus includes a pushing interpreter 110, a power button interpreter 120 and a button function information output device 130. The pushing interpreter 110 is electrically connected to a plurality of buttons 500 of the display 600 for determining whether one of the buttons 500 of the display 600 is pushed. The power button interpreter 120 is electrically connected to the pushing interpreter 110 for determining whether a power button is pushed when one of the buttons 500 of the display 600 is pushed. The button function information output device 130 is electrically connected to the power button interpreter 120 and the display 600 for outputting button function information onto the display 600 when one of the buttons 500 of the display 600 is pushed while the power button is not pushed.

According to one preferred embodiment, the on-screen display apparatus further includes a menu button interpreter 210. The menu button interpreter 210 is electrically connected to the pushing interpreter 110 for determining whether a menu button is pushed when the button function information is displayed on the display 600 while one of the buttons 500 of the display 600 is pushed. Moreover, a menu output device 220 may be electrically connected to the menu button interpreter 210 and the display 600 for outputting a menu onto the display 600 when the menu button is pushed.

In addition, the on-screen display apparatus may include a timer 310 electrically connected to the button function information output device 130 for timing how long the button function information has been displayed on the display 600. Furthermore, a closing information device 320 may be electrically connected to the timer 310 and the display 600 for closing the button function information displayed on the display 600 when a time timed by the timer equals a predetermined time.

In one embodiment of the invention, a power status interpreter 410 may be electrically connected to the power button interpreter 120 for determining a power status of the display 600 when the power button is pushed. If the power button is pushed while the power status of the display 600 is off, a starter 430 electrically connected to the power status interpreter 410 may be employed to turn on the display 600. On the contrary, if the power button is pushed while the power status of the display 600 is on, a closing device 420 electrically connected to the power status interpreter 410 may be employed to turn off the display 600.

Moreover, the display 600 according to one preferred embodiment of the invention may exclude words or symbols printed on a shell of the display 600 that represent button functions.

As embodied and broadly described herein, the on-screen display apparatus according to the preferred embodiment of the invention has advantages of:

(1) being able to display button function information on a display, liberating manufacturers from needing to print words or symbols representing button functions on the shell of the display, such that the display shell cost is reduced;

(2) displaying the button function information on the display rather than printing the button function information on the shell of display, such that the artistic design limitation of the display is relaxed;

(3) enabling designers to design varied types of button function information without being artistically limited by the print art and fonts because the button function information is displayed on the display rather than printed on the shell of the display; and

(4) not being limited to the size of the display shell.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An on-screen display apparatus for displaying button function information on a display, comprising:
a pushing interpreter for determining whether one of a plurality of buttons of the display is pushed, wherein the buttons comprise a power button;
a power button interpreter electrically connected to the pushing interpreter for determining whether the power button is pushed when one of the buttons of the display is pushed; and
a button function information output device electrically connected to the power button interpreter for outputting the button function information onto the display when one of the buttons of the display is pushed while the power button is not pushed.

2. The on-screen display apparatus of claim 1, further comprising:
a menu button interpreter electrically connected to the pushing interpreter for determining whether a menu button is pushed when the button function information is displayed on the display while one of the buttons of the display is pushed.

3. The on-screen display apparatus of claim 2, further comprising:
a menu output device electrically connected to the menu button interpreter for outputting a menu onto the display when the menu button is pushed.

4. The on-screen display apparatus of claim 1, further comprising:
a timer electrically connected to the button function information output device for timing how long the button function information has been displayed on the display.

5. The on-screen display apparatus of claim 4, further comprising:
a closing information device electrically connected to the timer for closing the button function information displayed on the display when a time timed by the timer equals a predetermined time.

6. The on-screen display apparatus of claim 1, further comprising:
a power status interpreter electrically connected to the power button interpreter for determining a power status of the display when the power button is pushed.

7. The on-screen display apparatus of claim 6, further comprising:
a starter electrically connected to the power status interpreter for turning on the display when the power button is pushed while the power status of the display is off.

8. The on-screen display apparatus of claim 6, further comprising:
a closing device electrically connected to the power status interpreter for turning off the display when the power button is pushed while the power status of the display is on.

9. The on-screen display apparatus of claim 1, wherein the display excludes a word printed on a shell of the display representing the button function information.

10. The on-screen display apparatus of claim 1, wherein the display excludes a symbol printed on a shell of the display representing the button function information.
